(19) United States
(12) Patent Application Publication
(10) Pub. No.: US 2016/0253145 A1
(43) Pub. Date: Sep. 1, 2016

(54) ELECTRONIC DEVICE AND METHOD FOR CONTROLLING THE SAME

(71) Applicant: LG ELECTRONICS INC., Yeongdeungpo-gu, Seoul (KR)

(72) Inventors: Seokhee LEE, Seoul (KR); Hyunkook KHANG, Seoul (KR); Seongpyo HONG, Seoul (KR); Inhye SEO, Seoul (KR)

(73) Assignee: LG ELECTRONICS INC., Seoul (KR)

(21) Appl. No.: 15/028,208

(22) PCT Filed: Oct. 31, 2014
(86) PCT No.: PCT/KR2014/010396

§ 371 Date: Apr. 8, 2016

(30) Foreign Application Priority Data
Oct. 31, 2013 (KR) 10-2013-0131441

(51) Int. Cl. G06F 3/16; H04R 3/00

(52) U.S. Cl. CPC G06F 3/162; G06F 3/165; H04R 3/00; H04R 2420/07; H04R 2420/03; H04R 2420/05

(57) ABSTRACT

The present invention relates to an electronic device and a method for controlling an electronic device. The present invention is capable of receiving local network information by accessing a wireless access device via a wireless communication part, receiving the local network information to a first speaker and requesting, through the first speaker, at least one second speaker that is synchronizable with the first speaker to share the local network information.

### TECHNICAL FIELD

The present invention relates to an electronic device and a method of controlling the same that set and control a plurality of electronic devices included in a local network.

### BACKGROUND ART

Nowadays, with development of hardware and software and fusion between networks, various methods of communication can be performed between electronic devices, and a use range of the electronic device has been largely increased.

Accordingly, it is necessary that an electronic device that can communicate with an external electronic device provides a more friendly user interface (UI), and in order for a user to simultaneously enjoy various contents in a plurality of electronic device (e.g., 3-screen play, 5-screen play), various methods that can efficiently control the electronic device are required.

### DISCLOSURE

### Technical Problem

The present invention provides an electronic device and a method of controlling the same being capable of providing a user interface that can set at one time a plurality of electronic devices in a DLNA network environment and that can intuitively group and manage a plurality of electronic devices included in a DLNA network.

### Technical Solution

In accordance with an aspect of the present invention, an electronic device includes: a wireless communication unit; and a controller configured to connect to a wireless access device through the wireless communication unit to receive local network information and to transmit the local network information to a first speaker and to request sharing of the local network information to at least one second speaker that can synchronize with the first speaker through the first speaker.

In accordance with another aspect of the present invention, a method of controlling an electronic device includes: connecting to a wireless access device to receive local network information; transmitting the local network information to a first speaker and requesting sharing of the local network information to at least one second speaker that can synchronize with the first speaker through the first speaker; receiving, when the first speaker and the at least one second speaker connect to the wireless access device, information about the connected plurality of speakers; and displaying the information about the plurality of speakers into a partitioned area or a representative icon.

The detailed matters of the embodiments will be included in the detailed description and the drawings.

### Advantageous Effects

An electronic device and a method of controlling the same according to the present invention have the following effect.

According to the present invention, by transmitting local network information to one of a plurality of electronic devices that can be synchronized and by controlling to share local network information transmitted from a plurality of electronic devices that can be synchronized, local network setting can be simply performed.

According to the present invention, grouping of a plurality of electronic devices included in a local network and the control of a grouped plurality of electronic devices can be intuitively displayed.

According to the present invention, an electronic device can control to integrally manage a music file in which a plurality of electronic devices included in a local network can access.

### BRIEF DESCRIPTION OF THE DRAWINGS

FIGS. 1 and 2 are schematic diagrams illustrating a system environment according to an exemplary embodiment of the present invention.

FIG. 3 is a conceptual diagram illustrating a DLNA network according to an exemplary embodiment of the present invention.

FIG. 4 is a block diagram illustrating a configuration of an electronic device according to an exemplary embodiment of the present invention.

FIG. 5 is a flowchart illustrating a method of controlling an electronic device according to an exemplary embodiment of the present invention.

FIGS. 6 to 8 are diagrams illustrating a method of setting a plurality of speakers to a local network in an electronic device according to an exemplary embodiment of the present invention.

FIG. 9 is a flowchart illustrating a method of integrally managing a plurality of speakers included in a local network in an electronic device according to an exemplary embodiment of the present invention.

FIGS. 10 to 27 are diagrams illustrating a method of integrally managing a plurality of speakers included in a local network in an electronic device according to an exemplary embodiment of the present invention.

### DETAILED DESCRIPTION

The above object, characteristics, and merit of the present invention will become more readily apparent through a detailed description in relation to the attached drawings. Hereinafter, an exemplary embodiment according to the present invention will be described in detail with reference to the attached drawings. Like reference numerals designate like elements throughout the specification. Further, detailed descriptions of well-known functions and structures incorporated herein may be omitted to avoid obscuring the subject matter of the present invention.

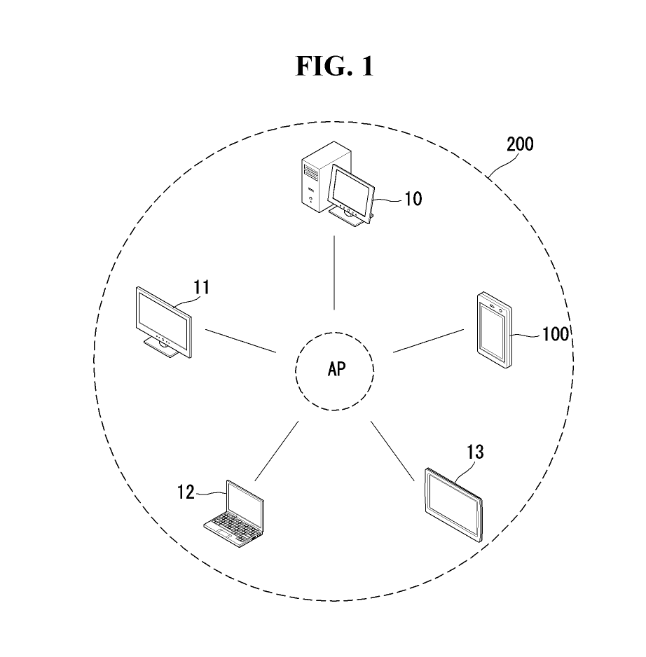

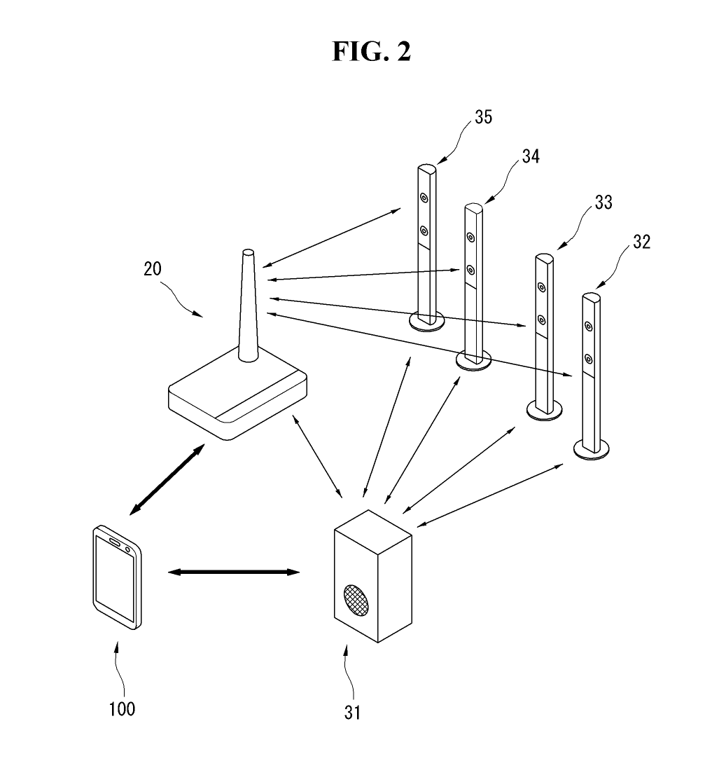

FIGS. 1 and 2 are schematic diagrams illustrating a system environment according to an exemplary embodiment of the present invention.

Referring to FIGS. 1 and 2, a system environment according to an exemplary embodiment of the present invention may include a plurality of electronic devices 10, 11, 12, 13, and 100 and a Home Access Point (AP) 20, and at least one of the plurality of electronic devices 10, 11, 12, 13, and 100 may be connected to a plurality of speakers 31 to 35 by wireless.

As shown in FIG. 1, the plurality of electronic devices 10, 11, 12, 13, and 100 and the plurality of speakers 31 to 35 may form a local network 200 such as Universal Plug and Play (UPnP) and Digital Living Network Alliance (DLNA).

As shown in FIG. 1, the plurality of electronic devices 10, 11, 12, 13, and 100 may communicate by a wireless or wire communication method.

In this document, a method in which the plurality of electronic devices 10, 11, 12, 13, and 100 communicate is not limited thereto. The scope of the present invention may be applied to an entire wireless communication method between existing electronic devices and an entire communication method to appear in the future.

For example, the plurality of electronic devices 10, 11, 12, 13, and 100 and the plurality of speakers 31 to 35 may communicate by a communication method such as UPnP, DLNA, and WiFi.

Further, for example, the plurality of electronic devices 10, 11, 12, 13, and 100 and the plurality of speakers 31 to 35 may communicate with a WiFi communication method through an access point (AP) 20 while forming a DLNA network 200.

Further, for example, the plurality of electronic devices 10, 11, 12, 13, and 100 and the plurality of speakers 31 to 35 may communicate through the network 200 or by a short range communication method.

The plurality of electronic devices 10, 11, 12, 13, and 100 may be a stationary terminal or a moving terminal.

The plurality of electronic devices 10, 11, 12, 13, and 100 may include, for example, a mobile phone, a smart phone, a computer, a laptop computer, a digital broadcasting terminal, Personal Digital Assistants (PDA), a Portable Multimedia Player (PMP), a navigation device, and a Mobile Internet Device (MID).

The plurality of speakers 31 to 35 are an external output device that can be connected to another electronic device by wire and wireless and are an electronic device that can independently output sound or that can output multichannel sound together with another speaker.

The plurality of electronic devices 10, 11, 12, 13, and 100 and the plurality of speakers 31 to 35 each may operate by any one of a digital media server (DMS), a digital media player (DMP), and a digital media renderer (DMR) in a DLNA network environment.

As shown in FIG. 2, in this document, it is assumed that the electronic device 100 is a mobile phone and that the plurality of speakers 31 to 35 operate with the DMR and the DMP, and various exemplary embodiments will be described.

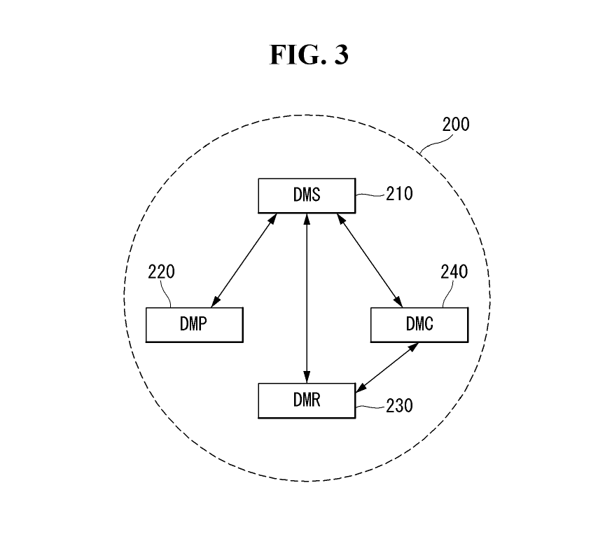

FIG. 3 is a conceptual diagram illustrating a DLNA network according to an exemplary embodiment of the present invention.

Referring to FIG. 3, the plurality of electronic device or and the plurality of speakers are an example for mutual compatibility and content sharing, and a network 200 according to a DLNA will be described.

The DLNA is a network and is a standardization device that enables to share contents such as music, a moving picture, and a still picture between electronic devices.

The DLNA is operated based on a Universal Plug and Play (UPnP) protocol.

The DLNA network 200 may include a digital media server (DMS) 210, a digital media player (DMP) 220, a digital media renderer (DMR) 230, and a digital media controller (DMC) 240.

The DLNA network 200 may include at least one of each of the DMS 210, the DMP 220, the DMR 230, and the DMC 240. In this case, the DLNA may provide a specification for mutual compatibility of the devices. Further, the DLNA network 200 may provide a specification for mutual compatibility between the DMS 210, the DMP 220, the DMR 230, and the DMC 240.

The DMS 210 may provide digital media contents. That is, the DMS 210 may store and manage contents. The DMS 210 may receive various commands from the DMC 240 and perform the received command. For example, when receiving a play command, the DMS 210 may search for contents to reproduce and provide the contents to the DMR 230. The DMS 210 may include, for example, a personal computer (PC), a Personal Video Recorder (PVR), and a set-top box.

The DMP 220 may control contents or an electronic device and enable contents to be reproduced. That is, the DMP 220 may perform a function of the DMR 230 for reproducing contents and the DMC 240 for the control of another electronic device. The DMP 220 may include, for example, a television (TV), a digital television (DTV), and a home theater.

The DMR 230 may reproduce contents received from the DMS 210. The DMR 230 may reproduce contents received from the DMS 210. The DMR 230 may include, for example, an electronic frame, a computer, and a MID.

The DMC 240 may provide a control function of controlling the DMS 210, the DMP 220, and the DMR 230. The DMC 240 may include, for example, a computer, a mobile phone, and a PDA.

Further, the DLNA network 200 may be formed with the DMS 210, DMR 230, and DMC 240 or may be formed with the DMP 220 and DMR 230

Further, the DMS 210, the DMP 220, the DMR 230, and the DMC 240 may be a term that functionally classifies electronic devices. For example, when the mobile phone has a reproduction function as well as a control function, the mobile phone may correspond to the DMP 220, and when the DTV 100 stores and manages contents, the mobile phone may correspond to the DMS 210 as well as the DMP 220.

For example, as shown in FIG. 2, the electronic device 100 may perform a function corresponding to at least one of the DMS 210, the DMP 220, the DMR 230, and the DMC 240, and in order to perform a function corresponding to the DMR or the DMP, the plurality of speakers 31 to 35 may form the DLNA network 200.

Hereinafter, as an example of the plurality of electronic devices 10, 11, 12, 13, and 100, the electronic device 100 will be described in detail with reference to the drawings. In the following description, suffixes “module” and “unit” may be given to components in consideration of only facilitation of description and do not have meanings or functions discriminated from each other.

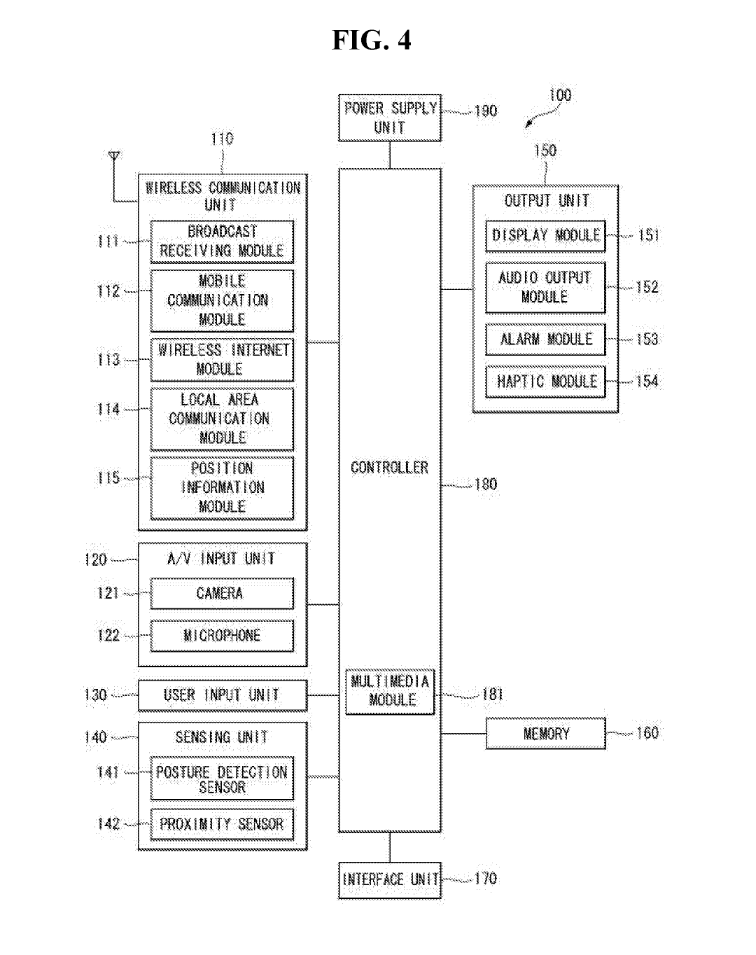

FIG. 4 is a block diagram of an electronic device in accordance with an example embodiment.

The electronic device 100 includes a wireless communication unit 110, an audio/video (A/V) input unit 120, a user input unit 130, a sensing unit 140, an output unit 150, a memory 160, an interface unit 170, a controller 180, a power supply 190, and so on. The components of FIG. 4 do not essential components, although other components may also be used. More or less components may alternatively be implemented.

Hereinafter, the constituent elements will be sequentially described.

The wireless communication unit 110 may include at least one module that enables wireless communication between the electronic device 100 and a wireless communication system or between the electronic device 100 and a network in which the electronic device 100 is located. For example, the wireless communication unit 110 may include a broadcast receiving module 111, a mobile communication module 112, a wireless Internet module 113, a local area communication module 114, a position information module 115 and so on.

The broadcast receiving module 111 may receive a broadcast signal and/or broadcast associated information from an external broadcast managing entity via a broadcast channel.

The broadcast channel may include a satellite channel and a terrestrial channel. The broadcast managing entity may refer to a system that transmits a broadcast signal and/or broadcast associated information. The broadcasting signal may include a broadcasting signal of a form in which a data broadcasting signal is coupled to a TV broadcasting signal or a radio broadcasting signal as well as a TV broadcasting signal, a radio broadcasting signal, and a data broadcasting signal.

The broadcasting related information may be information related to a broadcasting channel, a broadcasting program, or a broadcasting service provider. The broadcasting related information may be provided through a mobile communication network. In such a case, the broadcasting related information may be received by the mobile communication module 112.

The broadcasting related information may exist in various forms. For example, the broadcasting related information may exist in a form of an Electronic Program Guide (EPG) of Digital Multimedia Broadcasting (DMB) or an Electronic Service Guide (ESG) of Digital Video Broadcast-Handheld (DVB-H).

The broadcast receiving module 111 may receive broadcast signals transmitted from various types of broadcast systems. As a non-limiting example, the broadcasting systems may include digital multimedia broadcasting-terrestrial (DMB-T), digital multimedia broadcasting-satellite (DMB-S), digital video broadcast-handheld (DVB-H), a data broadcasting system known as media forward link only (MediaFLO®) and integrated services digital broadcast-terrestrial (ISDB-T). The receiving of multicast signals may also be provided.

Data received by the broadcast receiving module 111 may be stored in the memory 160, for example.

The mobile communication module 112 transmits and receives a wireless signal to and from at least one of a base station, an external terminal, and a server on a mobile communication network. The wireless signal may include various forms of data according to transmission and reception of a voice call signal, an audiovisual communication call signal, or a text/multimedia message.

The wireless Internet module 113 may support Internet access for the mobile device 100. This wireless Internet module 113 may be internally or externally coupled to the electronic device 100. Suitable technologies for wireless Internet may include, but are not limited to, WLAN (Wireless LAN)(Wi-Fi), Wibro (Wireless broadband), Wimax (World Interoperability for Microwave Access), and/or HSDPA (High Speed Downlink Packet Access). The wireless Internet module 113 may be replaced with a wire Internet module in non-mobile devices. The wireless Internet module 113 and the wire Internet module may be referred to as an Internet module.

The local area communication module 114 may facilitate local area communications. Suitable technologies for local area communication may include, but are not limited to, radio frequency identification (RFID), infrared data association (IrDA), ultra-wideband (UWB), as well as networking technologies such as Bluetooth and ZigBee.

The position information module 115 may identify or otherwise obtain a location of the electronic device 100. The position information module 115 may be provided using global positioning system (GPS) components that cooperate with associated satellites, network components, and/or combinations thereof. Here, a Global Navigation Satellite System (GNSS) is a term using for describing wireless navigation satellite systems in which predetermined types of wireless navigation receivers send reference signals that can determine a location thereof at a surface of the earth or a periphery of a surface of the earth by revolving the earth. The GNSS may include a Global Position System (GPS) operating in US, Galileo operating in Europe, Global Orbiting Navigational Satellite System (GLONASS) operating in Russia, COMPASS operating in China, and Quasi-Zenith Satellite System (QZSS) operating in Japan.

The representative position information module 115 of the GNSS may be, for example, a Global Position System (GPS) module. The GPS module may calculate information about a distance from one point (entity) to three or more satellites and information about a time at which the distance information is measured and apply trigonometry to the calculated distance information, thereby calculating three-dimensional location information according to latitude, longitude, and altitude of the one point (entity) at one time. In addition, a method of calculating location and time information using three satellites and adjusting an error of the calculated location and time information using another one satellite may be also used. The GPS module may continuously calculate a current location in real time and calculate velocity information using the calculated current location.

Referring to FIG. 4, the audio/video (A/V) input unit 120 may provide audio or video signal input to the mobile device 100. The AN input unit 120 may include a camera 121 and a microphone 122. The camera 121 may receive and process image frames of still pictures and/or video. The processed image frame may be displayed in the display unit 151.

An image frame processed in the camera 121 may be stored at the memory 160 or may be transmitted to the outside through the wireless communication unit 110. The camera 121 may be provided with at least two according to a configuration aspect of a terminal.

The microphone 122 receives an input of an external audio signal by a microphone in a communication mode or a recording mode, and a voice recognition mode and processes the external audio signal into electrical voice data. In a communication mode, the processed voice data may be converted and output into a form that can transmit to a mobile communication base station through the mobile communication module 112. In the microphone 122, various noise removal algorithms for removing noise occurring in a process of receiving an input of an external audio signal may be implemented.

The user input unit 130 may generate input data responsive to user manipulation of an associated input device or devices. Examples of such devices may include a keypad, a dome switch, a touchpad (e.g., static pressure/capacitance), a jog wheel and/or a jog switch. A specific example is one in which the user input unit 130 is configured as a touchpad in cooperation with a display, as will be described below.

The sensing unit 140 may provide status measurements of various aspects of the electronic device 100. For example, the sensing unit 140 may detect an open/close status (or state) of the electronic device 100, a relative positioning of components (e.g., a display and a keypad) of the electronic device 100, a change of position of the electronic device 100 or a component of the electronic device 100, a presence or absence of user contact with the electronic device 100, and/or an orientation or acceleration/deceleration of the electronic device 100. For example, the electronic device 100 may be configured as a slide-type mobile device. In such a configuration, the sensing unit 140 may sense whether a sliding portion of the mobile device 100 is open or closed. The sensing unit 140 may also sense presence or absence of power provided by the power supply 190, presence or absence of a coupling or other connection between the interface unit 170 and an external device, etc. The sensing unit 140 may include a proximity sensor 141.

The output unit 150 may generate an output relevant to a sight sense, an auditory sense, a tactile sense and/or the like. The output unit 150 may include a display module 151, an audio output module 152, an alarm module 153, a haptic module 154 and/or the like.

The display module 151 may display (output) information processed by the device 100. For example, in case that the device is in a call mode, the display module 151 may display a user interface (UI) or a graphic user interface (GUI) associated with the call. If the electronic device 100 is in a video communication mode or a photograph mode, the display module 151 may display a photographed and/or received picture, a UI or a GUI.

The display module 151 may include at least one of a liquid crystal display (LCD), a thin film transistor liquid crystal display (TFT LCD), an organic light-emitting diode (OLED), a flexible display, and a 3-dimensional display.

The display module 151 may have a transparent or light-transmissive type configuration to enable an external environment to be seen through. This may be called a transparent display. A transparent OLED (TOLED) may be an example of a transparent display. A backside structure of the display module 151 may also have the light-transmissive type configuration. In this configuration, a user may see an object located behind the device body through the area occupied by the display module 151 of the device body.

At least two displays 151 may also be provided. For example, a plurality of displays may be provided on a single face of the device 100 by being built in one body or spaced apart from the single face. Alternatively, each of a plurality of displays may be provided on different faces of the device 100.

If the display module 151 and a sensor for detecting a touch action (hereafter a touch sensor) are constructed in a mutual-layered structure (hereafter a touchscreen), the display module 151 may be used as an input device as well as an output device. For example, the touch sensor may include a touch film, a touch sheet, a touchpad and/or the like.

The touch sensor may convert a pressure applied to a specific portion of the display module 151 or a variation of electrostatic capacity generated from a specific portion of the display module 151 to an electric input signal. The touch sensor may detect a pressure of a touch as well as a position and size of the touch.

If a touch input is provided to the touch sensor, signal(s) corresponding to the touch input may be transferred to a touch controller. The touch controller may process the signal(s) and then transfer corresponding data to the controller 180. The controller 180 may therefore know which portion of the display module 151 is touched.

The proximity sensor can be provided within the electronic device 100 enclosed by the touchscreen or around the touchscreen. The proximity sensor may detect a presence or non-presence of an object approaching a prescribed detecting surface or an object existing around the proximity sensor using an electromagnetic field strength or infrared ray without mechanical contact. The proximity sensor may have a longer durability than the contact type sensor and may also have a greater usage than the contact type sensor.

The proximity sensor may include one of a transmissive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and/or the like.

If the touchscreen is an electrostatic type, the proximity sensor 141 may detect proximity of a pointer using a variation of an electric field according to the proximity of the pointer. In this case, the touchscreen (touch sensor) may be classified into the proximity sensor.

An action in which a pointer approaches the touchscreen without contacting the touchscreen may be called a proximity touch. An action in which a pointer actually touches the touchscreen may be called a contact touch. The location of the touchscreen proximity-touched by the pointer may be the position of the pointer that vertically opposes the touchscreen when the pointer performs the proximity touch.

The proximity sensor 141 may detect a proximity touch and/or a proximity touch pattern (e.g., a proximity touch distance, a proximity touch duration, a proximity touch position, a proximity touch shift state, etc.). Information corresponding to the detected proximity touch action and/or the detected proximity touch pattern may be outputted to the touchscreen.

The audio output module 152 may output audio data that is received from the wireless communication unit 110 in a call signal reception mode, a call mode, a recording mode, a voice recognition mode, a broadcast receiving mode and/or the like. The audio output module 152 may output audio data stored in the memory 160. The audio output module 152 may output an audio signal relevant to a function (e.g., a call signal receiving sound, a message receiving sound, etc.) performed by the mobile device 100. The audio output module 152 may include a receiver, a speaker, a buzzer and/or the like.

The alarm module 153 may output a signal for announcing an event occurrence of the mobile device 100. An event occurring in the mobile device 100 may include one of a call signal reception, a message reception, a key signal input, a touch input and/or the like. The alarm module 153 may output a signal for announcing an event occurrence by way of vibration or the like as well as a video signal or an audio signal. The video signal may be outputted via the display module 151. The audio signal may be outputted via the audio output module 152. The display module 151 or the audio output module 152 may be classified as part of the alarm module 153.

The haptic module 154 may bring about various haptic effects that can be sensed by a user. Vibration is a representative example for the haptic effect brought about by the haptic module 154. Strength and pattern of the vibration generated from the haptic module 154 may be controllable. For example, vibrations differing from each other may be outputted in a manner of being synthesized together or may be sequentially outputted.

The haptic module 154 may generate various haptic effects including a vibration, an effect caused by such a stimulus as a pin array vertically moving against a contact skin surface, a jet power of air via outlet, a suction power of air via inlet, a skim on a skin surface, a contact of an electrode, an electrostatic power and the like, and/or an effect by hot/cold sense reproduction using an endothermic or exothermic device as well as the vibration.

The haptic module 154 may provide the haptic effect via direct contact. The haptic module 154 may enable a user to experience the haptic effect via muscular sense of a finger, an arm and/or the like. Two or more haptic modules 154 may be provided according to a configuration of the mobile device 100.

The memory 160 may store a program for operations of the controller 180. The memory 160 may temporarily store input/output data (e.g., phonebook, message, still picture, moving picture, etc.). The memory 160 may store data of vibration and sound in various patterns outputted in case of a touch input to the touchscreen.

The memory 160 may include at least one of a flash memory, a hard disk, a multimedia card micro type memory, a card type memory (e.g., SD memory, XD memory, etc.), a random access memory (RAM), a static random access memory (SRAM), a read-only memory (ROM), an electrically erasable programmable read-only memory, a programmable read-only memory, a magnetic memory, a magnetic disk, an optical disk, and/or the like. The mobile device 100 may operate in association with a web storage that performs a storage function of the memory 160 in the Internet.

The interface unit 170 may play a role as a passage to external devices connected to the electronic device 100. The interface unit 170 may receive data from an external device. The interface unit 170 may be supplied with a power and then the power may be delivered to elements within the electronic device 100. The interface unit 170 may enable data to be transferred to an external device from an inside of the electronic device 100. The interface unit 170 may include a wire/wireless headset port, an external charger port, a wire/wireless data port, a memory card port, a port for coupling to a device having an identity module, an audio input/output (I/O) port, a video input/output (I/O) port, an earphone port and/or the like.

The identity module may be a chip or card that stores various kinds of information for authenticating use of the electronic device 100. The identify module may include a user identity module (UIM), a subscriber identity module (SIM), a universal subscriber identity module (USIM) and/or the like. A device provided with the above identity module (hereafter an identity device) may be manufactured in the form of a smart card. The identity device may be connected to the electronic device 100 via the port.

The interface unit 170 may play a role as a passage for supplying a power to the electronic device 100 from a cradle that is connected to the electronic device 100. The interface unit 170 may play a role as a passage for delivering various command signals, which are inputted from the cradle by a user, to the electronic device 100. Various command signals inputted from the cradle or the power may work as a signal for recognizing that the electronic device 100 is correctly loaded in the cradle.

The controller 180 may control overall operations of the mobile device 100. For example, the controller 180 may perform control and processing relevant to a voice call, a data communication, a video conference and/or the like. The controller 180 may have a multimedia module 181 for multimedia playback. The multimedia module 181 may be implemented within the controller 180 or may be configured separate from the controller 180.

The controller 180 may perform pattern recognizing processing for recognizing a handwriting input performed on the touchscreen as a character and/or recognizing a picture drawing input performed on the touchscreen as an image.

The power supply 190 may receive an external or internal power and then supply the power required for operations of the respective elements under control of the controller 180.

Embodiments of the present invention explained in the following description may be implemented within a recording medium that can be read by a computer or a computer-like device using software, hardware or combination thereof.

According to the hardware implementation, arrangements and embodiments may be implemented using at least one of application specific integrated circuits (ASICs), digital signal processors (DSPs), digital signal processing devices DSPDs), programmable logic devices (PLDs), field programmable gate arrays (FPGAs), processors, controllers, microcontrollers, microprocessors and electrical units for performing other functions. In some cases, embodiments may be implemented by the controller 180.

For a software implementation, arrangements and embodiments described herein may be implemented with separate software modules, such as procedures and functions, each of which may perform one or more of the functions and operations described herein. Software codes may be implemented with a software application written in any suitable programming language and may be stored in memory such as the memory 160, and may be executed by a controller or processor, such as the controller 180.

Hereinafter, exemplary embodiments of the present invention will be described.

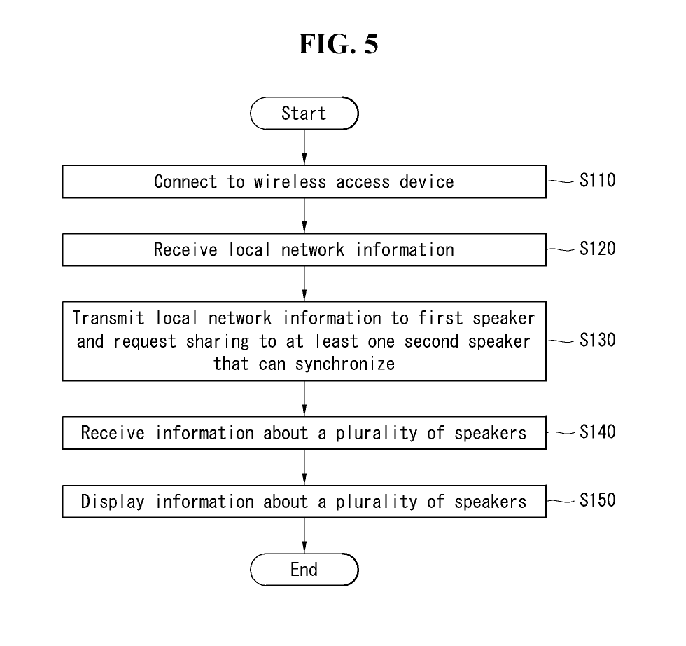

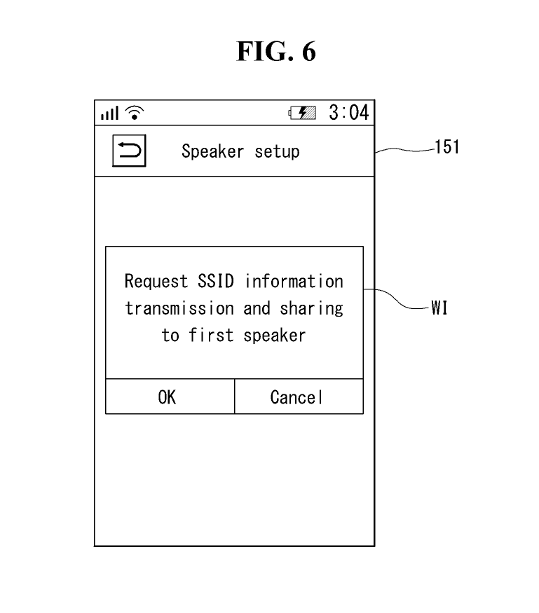

FIG. 5 is a flowchart illustrating a method of setting a speaker in an electronic device according to an exemplary embodiment of the present invention, and FIGS. 6 to 8 are diagrams illustrating a method of setting a speaker in an electronic device according to an exemplary embodiment of the present invention.

Referring to FIG. 5, the controller (180 of FIG. 4) of the electronic device may connect to the wireless access device (20 of FIG. 2) through the wireless communication unit (S110) and receive information of the local network (200 of FIG. 1) (S120).

The electronic device (100 of FIG. 2) may form a communication channel with the wireless access device (20 of FIG. 2) using a short range communication method such as WiFi and Bluetooth, determine whether at least one speaker is set to the wireless access device (20 of FIG. 2), and request local network information to the wireless access device, if at least one speaker is not set to the wireless access device.

Here, information of the local network (200 of FIG. 1) may be formed with authentication information and Service Set Identifier (SSID) of the wireless access device (20 of FIG. 2).

The controller (180 of FIG. 4) may transmit the received local network information to a first speaker and request sharing of local network information to at least one second speaker that can synchronize with the first speaker through the first speaker (S130).

When a communication channel is formed in the first speaker with a short range communication method, the controller (180 of FIG. 4) may transmit local network information formed with Service Set Identifier (SSID) and authentication information received from the wireless access device (20 of FIG. 2) to the first speaker through the communication channel. Further, when transmitting local network information, the controller (180 of FIG. 4) may request sharing of local network information to other speakers that can be synchronized.

The first speaker may be connected to the wireless access device using the received local network information and transfer and share the local network information to at least one second speaker. The at least one second speaker, having shared the local network information may be connected to the wireless access device using the shared local network information.

When the first speaker and at least one second speaker are connected to the wireless access device, the electronic device may receive information about a connected plurality of speakers from the wireless access device (S140).

The controller (180 of FIG. 4) of the electronic device may control to display the received information about the plurality of speakers into a partitioned area or a representative icon (S150).

Specifically, the controller (180 of FIG. 4) of the electronic device may classify information about a plurality of speakers connected to the wireless access device on each speaker basis and provide information to a user interface of a list form or an icon form. In this case, the controller (180 of FIG. 4) may provide a control state or location information of each speaker.

Referring to FIG. 6, when a communication channel is set to one of a plurality of speakers with a short range communication method in a speaker setup menu, the controller (180 of FIG. 4) may set a speaker in which a short range communication channel is formed to a first speaker.

Further, the controller (180 of FIG. 4) may transmit local network information to the first speaker and control to display a popup window W1 that requests sharing to a second speaker.

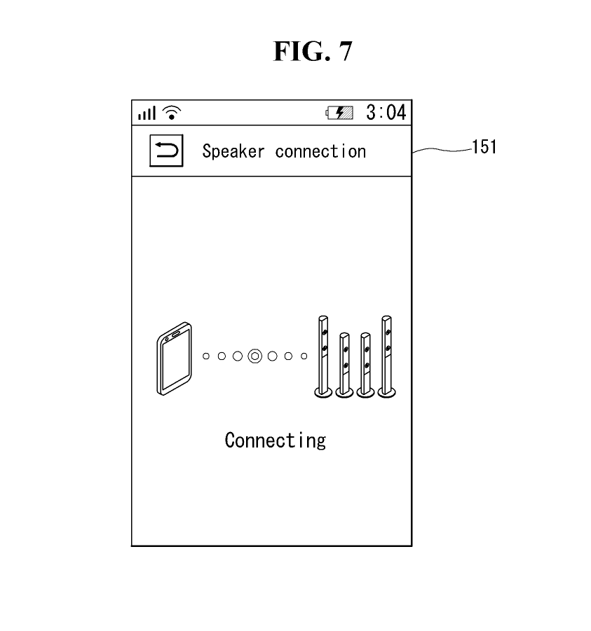

Referring to FIG. 7, when a determination input to a popup window W1 is received, the controller (180 of FIG. 4) may transmit local network information to the first speaker, request sharing with other speakers, and search for speakers connected to a wireless access device among a plurality of speakers, having received the local network information.

In this case, other speakers sharing the local network information may be synchronized with the first speaker and are initially preset speakers, when producing a speaker, or are compatible speakers.

Specifically, when the controller of the electronic device sets a specific speaker to a first speaker, the first speaker may receive local network information and a sharing request of the local network information from the electronic device. The first speaker may search for at least one connectable second speaker, transmit local network information and a preset control signal of the first speaker to at least one second speaker, and share local network information and a control signal.

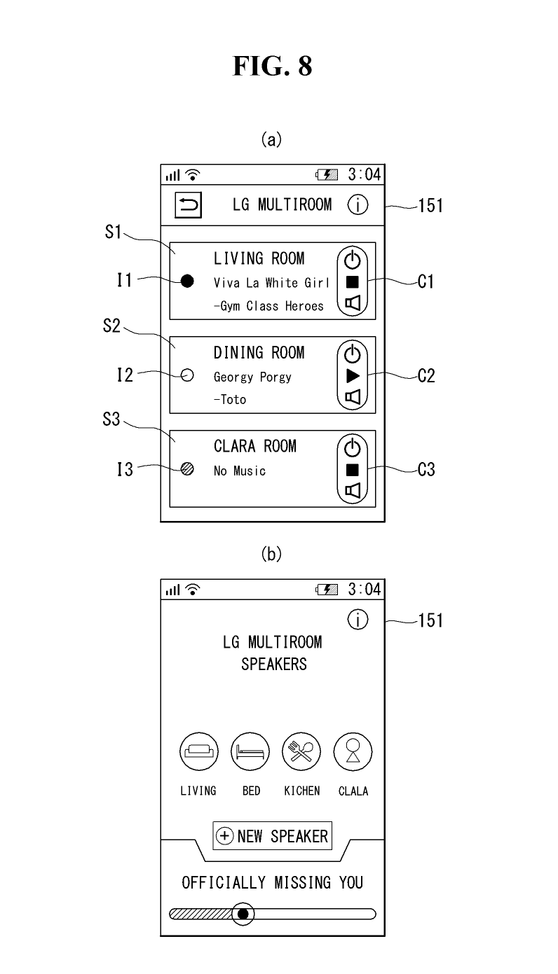

Referring to FIG. 8, the controller (180 of FIG. 4) may provide information about a plurality of speakers connected to a wireless access device to a user interface.

When an initial connection of a first speaker and at least one second speaker to the wireless access device is complete, the first speaker may receive from at least one second speaker notification that a connection to the wireless access device is complete and may transmit the notification to the controller of the electronic device. That is, a plurality of speakers and the electronic device connected to the wireless access device are included in one local network, and the electronic device to control the plurality of speakers may receive information of the plurality of speakers.

Specifically, when three speakers named ‘LIVING ROOM’, ‘DINING ROOM’, and ‘CLALA ROOM’ are connected to the wireless access device, the controller (180 of FIG. 4) may display information about three speakers in the user interface. Specifically, the controller (180 of FIG. 4) may provide information about each of three speakers named ‘LIVING ROOM’, ‘DINING ROOM’, and ‘CLALA ROOM’ in partitioned areas in a list form ((a) of FIG. 8). In the partitioned respective areas S1, S2, and S3, representative icons I1, I2, and I3 representing each speaker may be displayed, and function keys C1, C2, and C3 that can control a function of each speaker may be displayed together. In addition, the controller may control to display together music reproduction information of each speaker.

The controller (180 of FIG. 4) may control to display information about each of three speakers named ‘LIVING ROOM’, ‘DINING ROOM’, and ‘CLALA ROOM’ into a representative icon form ((b) of FIG. 8).

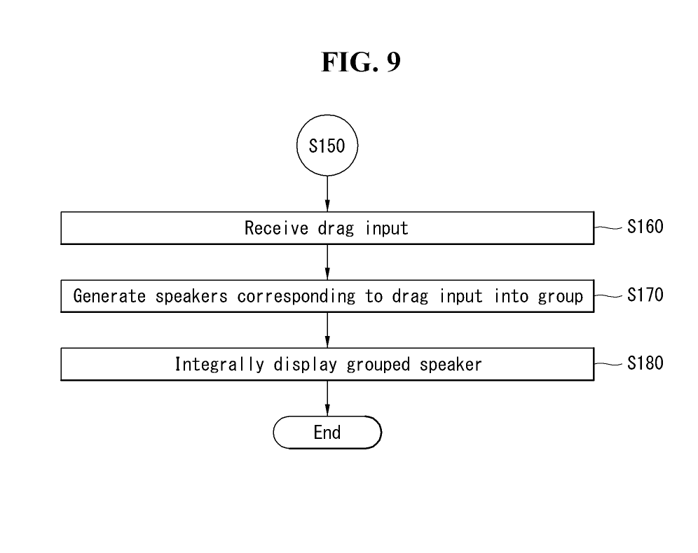

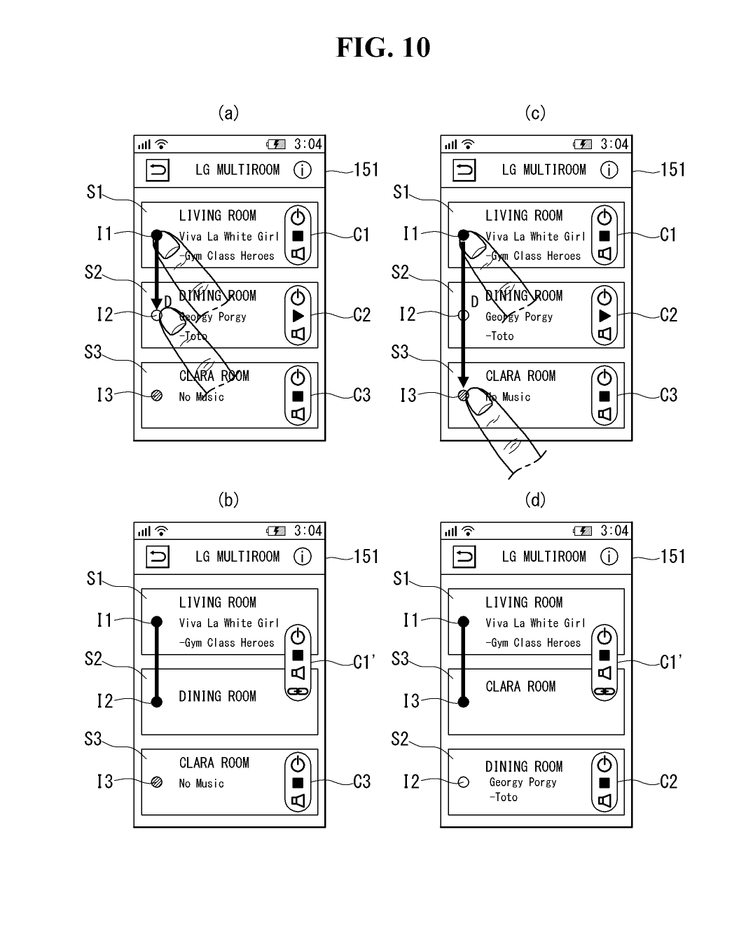

FIG. 9 is a flowchart illustrating a method of integrally managing a plurality of speakers included in a local network in an electronic device according to an exemplary embodiment of the present invention, and FIGS. 10 to 27 are diagrams illustrating a method of integrally managing a plurality of speakers included in a local network in an electronic device according to an exemplary embodiment of the present invention.

Referring to FIG. 9, in a state in which a plurality of speaker information included in a local network is displayed, when a drag input to an area allocated to each speaker or a representative icon of each speaker is received (S160), the controller (180 of FIG. 4) of the electronic device may generate speakers corresponding to the drag input into a group (S170).

Specifically, when a drag input in which a representative icon of a first speaker is a start point and a representative icon of a second speaker is an end point is received, the controller may generate the first speaker and the second speaker into one group. When receiving a drag input in which a representative icon of a first speaker is a start point and in which a representative icon of a third speaker is an end point by passing through a representative icon of a second speaker, the controller may generate the first speaker and the third speaker one into one group. That is, when receiving a drag input that terminates at a representative icon of a specific speaker, the controller may generate the specific speaker and a speaker corresponding to a start point of the drag input into one group. Further, the controller may generate speakers corresponding to entire representative icons that receive a drag input into one group.

The controller (180 of FIG. 4) may control to integrally display an area or an icon representing speakers included in the generated group into one or to display an area or an icon representing speakers included in the generated group into a group icon (S180).

The controller (180 of FIG. 4) may control to display a screen that selects whether speakers subordinated to operation of a main speaker are subordinated to at least one speaker formed into a group on a touch screen. Further, the controller (180 of FIG. 4) may control to display a screen that selects a function to be independently controlled and a function subordinated to a function of a main speaker among functions of a plurality of speakers that belong to the same group on a touch screen. Therefore, according to the present invention, the controller (180 of FIG. 4) may control to subordinate functions of a plurality of speakers that belong to the same group to a main speaker or may determine whether functions of a plurality of speakers that belong to the same group are selectively subordinated to a main speaker on a speaker function basis.

The controller (180 of FIG. 4) may set a speaker subordinated to a main speaker in consideration of a start point and an end point of a drag input and may generate a control signal that controls a subordinated speaker to be subordinated to a main speaker. Further, the controller (180 of FIG. 4) may transmit the generated control signal to both the main speaker and the subordinated speaker through the wireless access device. In this case, the controller may directly transmit a control signal of the main speaker to subordinated speakers included in the same group as that of the main speaker or may transmit a control signal of the main speaker to subordinated speakers included in the same group as that of the main speaker through the wireless access device.

The controller (180 of FIG. 4) may generate speakers corresponding to a drag input into one group and may control to give a surround effect to speakers included in the generated group according to a drag direction or may control to distribute and output a multichannel output signal.

The electronic device (100 of FIG. 2) may further include a sensing unit (140 of FIG. 4) that detects a tagging signal of at least one speaker (31 to 35 of FIG. 2) or a detection signal using Bluetooth Low Energy (BLE) technology. In this case, when the sensing unit detects a tagging signal or a detection signal, the controller (180 of FIG. 4) may store location information of the electronic device as location information of each speaker and control to display a partitioned area or a representative icon to correspond to location information of each speaker.

When the sensing unit detects a tagging signal or a detection signal, the controller may transmit the tagging signal or the detection signal to other speakers included in the same group and may control speakers included in the same group to continuously reproduce music. Specifically, while reproducing a first music file through speakers included in a first group, when receiving a tagging signal or a detection signal of one of speakers included in a second group, the controller may control an entire speaker included in the second group to continuously reproduce the reproducing first music file.

The controller (180 of FIG. 4) may control to display a menu icon that sets music reproduction information and a surround effect of a specific speaker of a plurality of speakers included in a local network on a touch screen. When receiving an input to a menu icon that sets a surround effect, the controller may control to display a screen that sets another speaker to give a surround effect to a specific speaker. Specifically, the controller may control to display a speaker list that can select a surround speaker of a specific speaker on a touch screen.

The controller (180 of FIG. 4) may control to display a menu icon that sets sharing of a reproduction music list and music reproduction information of a specific speaker of a plurality of speakers included in a local network on a touch screen. When receiving an input to a menu icon that sets sharing of a reproduction music list, the controller may share a reproduction music list of a specific speaker with another speaker. Specifically, the controller may transmit a reproduction music list and music files of a specific speaker to selected other speakers, thereby sharing reproduction music.

The controller (180 of FIG. 4) may transmit a music file of other electronic devices included in a local network to a first speaker, which is a main speaker and may control the first speaker and another electronic device to enable the first speaker to integrally manage the music file. In this case, another electronic device may include a CD player, an audio device, and a content provider (CP) server included in a local network. When a control signal for integration management of a music file is input to a specific speaker included in a local network, for integration management of a music file, the controller may transmit a control signal to the first speaker.

Hereinafter, a method in which an electronic device according to an exemplary embodiment of the present invention integrally manages a plurality of speakers included in a local network will be described in detail with reference to FIGS. 10 to 27.

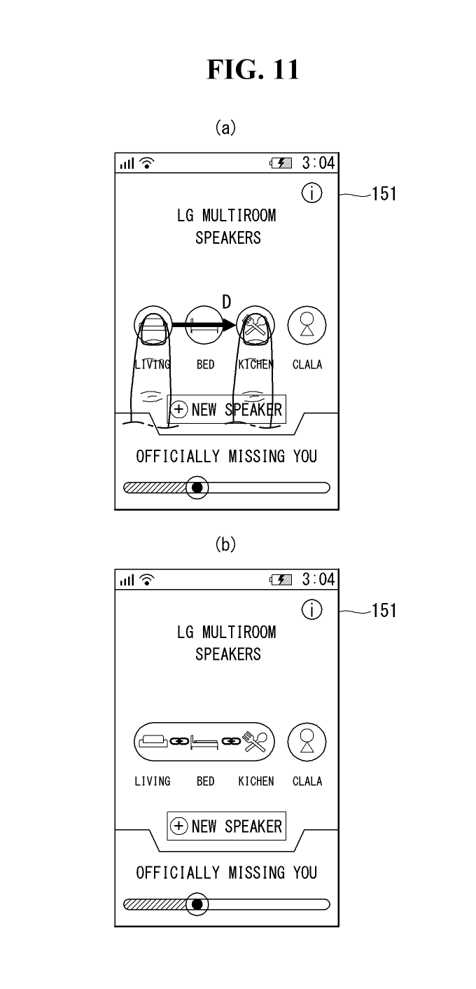

FIGS. 10 and 11 are diagrams illustrating a method of generating a group of a plurality of speakers included in a local network in an electronic device according to an exemplary embodiment of the present invention.

Referring to FIG. 10, when a drag input in which a representative icon II representing a speaker named ‘LIVING ROOM’ is a start point and in which a representative icon 12 representing a speaker named ‘DINING ROOM’ is an end point is received, the controller (180 of FIG. 4) may generate two speakers named ‘LIVING ROOM’ and ‘DINING ROOM’ into one group ((a), (b) of FIG. 10).

In order to represent each speaker included in a generated group, the controller (180 of FIG. 4) may correspond a form and a color of representative icons I1 and I2, integrates a function key of two speakers into one C1′, and provide the integrated key to a user interface.

With a similar method, a drag input in which a representative icon Il representing a speaker named ‘LIVING ROOM’ is a start point and in which a representative icon 12 representing a speaker named ‘CLARA ROOM’ is an end point is received, the controller (180 of FIG. 4) may generate two speakers ‘LIVING ROOM’ and ‘CLARA ROOM’ into one group ((c), (d) of FIG. 10).

The controller may generate two speakers into one group according to a start point and an end point of a drag input.

Referring to FIG. 11, when a drag input to a representative icon representing speakers named ‘LIVING’, ‘BED’, and ‘KITCHEN’ is received, the controller (180 of FIG. 4) may generate three speaker into one group.

The controller (180 of FIG. 4) may set a speaker named ‘LIVING’ corresponding to a start point of a drag input to a main speaker and set a speaker named ‘KITCHEN’ corresponding to an end point of a drag input to a subordinated speaker. Further, the controller (180 of FIG. 4) may generate a control signal that enables to subordinate a subordinated speaker to a main speaker. Therefore, the controller (180 of FIG. 4) may control at one time speakers named ‘LIVING’ and ‘KITCHEN’ to reproduce the same music.

Although not shown in the drawing, the controller may control to display a main speaker of a group with a specific indicator. For example, the controller may control to represent a lock symbol under a ‘LIVING’ icon, which is a main speaker.

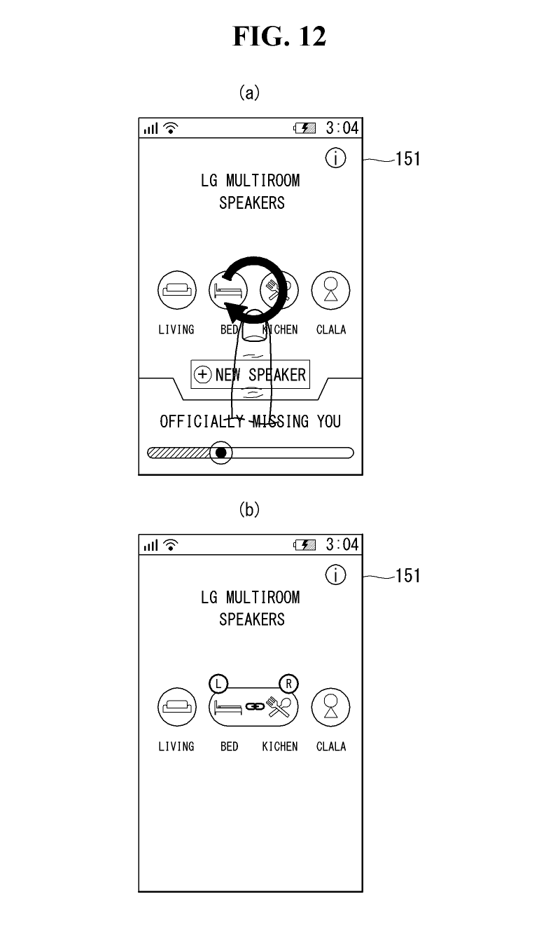

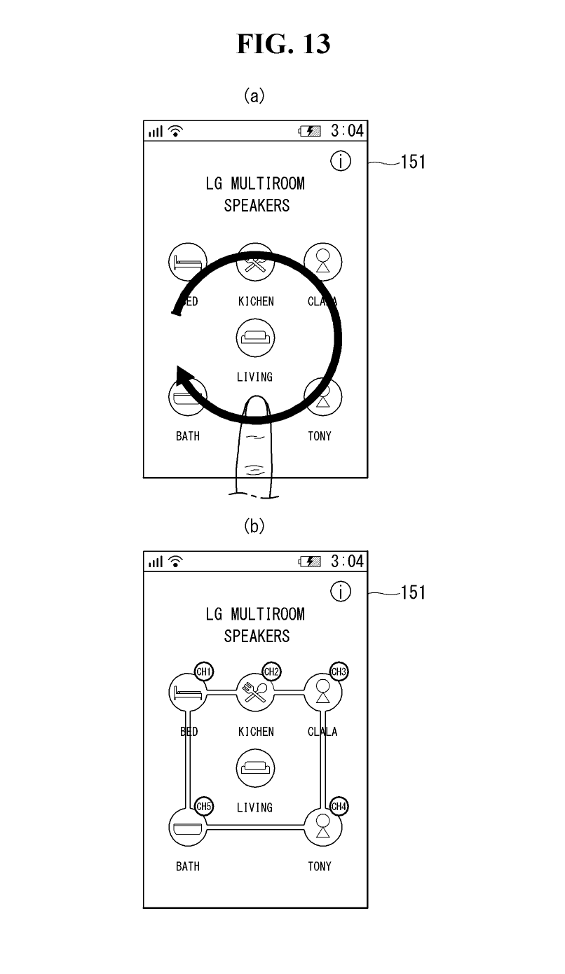

FIGS. 12 and 13 are diagrams illustrating a method of generating a plurality of speakers included in a local network into a group and distributing a multichannel output signal (surround setting) in the electronic device according to an exemplary embodiment of the present invention.

Referring to FIG. 12, when a drag input to a partitioned area or a representative icon is received, the controller (180 of FIG. 4) may generate speakers corresponding to the drag input into one group and control to distribute a multichannel output signal to each speaker according to a drag direction.

Specifically, when a clockwise drag input passing through a representative icon representing two speakers named ‘BED’ and ‘KITCHEN’ is received, the controller (180 of FIG. 4) may control to distribute and output left and right stereo output signals to a ‘BED’ speaker displayed at the left side and a ‘KITCHEN’ speaker displayed at the right side, respectively.

The controller (180 of FIG. 4) may control to display indicators L and R representing a stereo output signal direction on a representative icon corresponding to a speaker that outputs a left/right stereo output signal.

Referring to FIG. 13, the controller (180 of FIG. 4) may control to display a representative icon to correspond to a speaker location, and when a drag input to specific representative icons is received, the controller (180 of FIG. 4) may generate specific representative icons into a group and control to distribute a multichannel output signal to each speaker according to a drag direction.

Specifically, the controller (180 of FIG. 4) may store location information of a time point at which a tagging signal of each speaker is received in the sensing unit as location information of each speaker and controls to display a representative icon representing a speaker according to each location information. For example, speakers named ‘BED’, ‘KITCHEN’, and ‘CLALA’ may be disposed in an upper portion of a speaker named ‘LIVING’, and speakers named ‘BATH’ and ‘TONY’ may be disposed in a lower portion of a speaker named ‘LIVING’.

When a clockwise drag input passing through speakers named ‘BED’, ‘KITCHEN’, ‘CLALA’, ‘TONY’, and ‘BATH’ is received, the controller (180 of FIG. 4) may control to distribute and output a multichannel output signal in received order of the drag input.

The controller (180 of FIG. 4) may control to display indicators CH1 to CH5 representing distribution of a multichannel output signal on a representative icon representing each speaker.

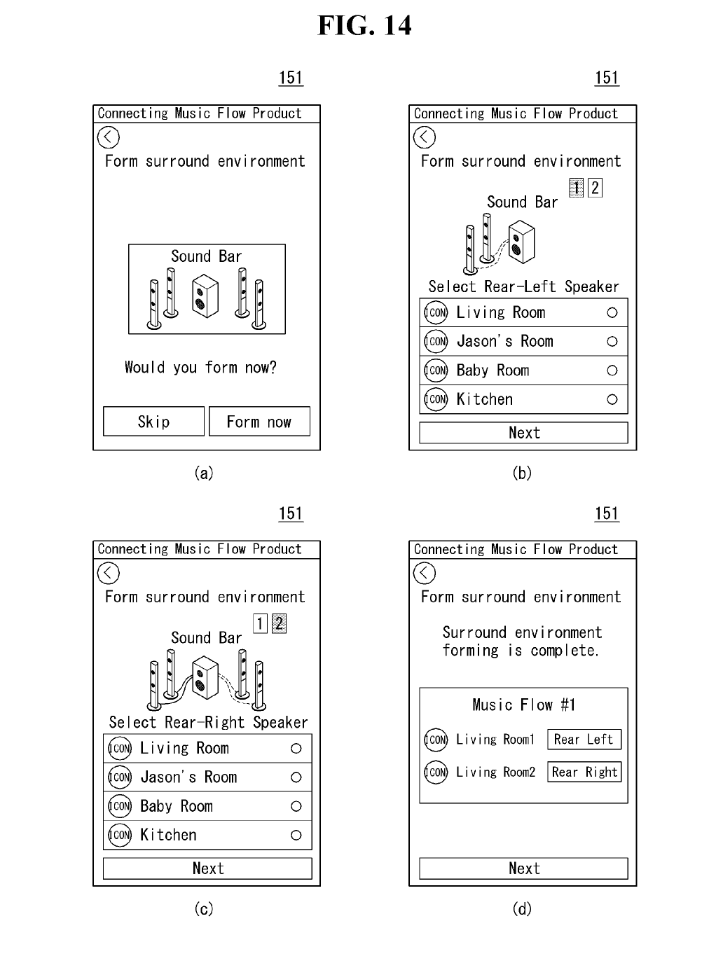

FIG. 14 is a diagram illustrating a method of setting a surround effect of a plurality of speakers included in a local network in an electronic device according to an exemplary embodiment of the present invention.

Referring to FIG. 14, the controller (180 of FIG. 4) may select a ‘Sound Effect’ menu while reproducing music in a specific speaker (Sound Bar) and select a speaker to give a surround effect to the specific speaker (Sound Bar).

The controller may control to display a speaker list, ‘Living Room’, ‘Jason's Room’, ‘Baby Room’, and ‘Kitchen’ connected to the local network on the touch screen 151. In this case, the controller may control to display together a channel (left or right, CH1, CH2, and CH3) of a speaker to give a surround effect.

The controller may control to display connectable channel information (Left Speaker CH1, Right Speaker CH2) and a connectable speaker list and may change display of a channel to connect on a speaker list selection screen. For example, when selecting a speaker to connect to a Right Speaker, a connection line of the Right Speaker and the Sound Bar may be displayed by a dotted line.

Specifically, as a Left Speaker CH1 to give a surround effect to the Sound Bar speaker, when a Living Room 1 speaker is selected, and as a Right Speaker CH2 to give a surround effect to the Sound Bar speaker, when a Living Room 2 speaker is selected, the controller may control to display information of a main speaker and a left or right surround speaker on the touch screen 151.

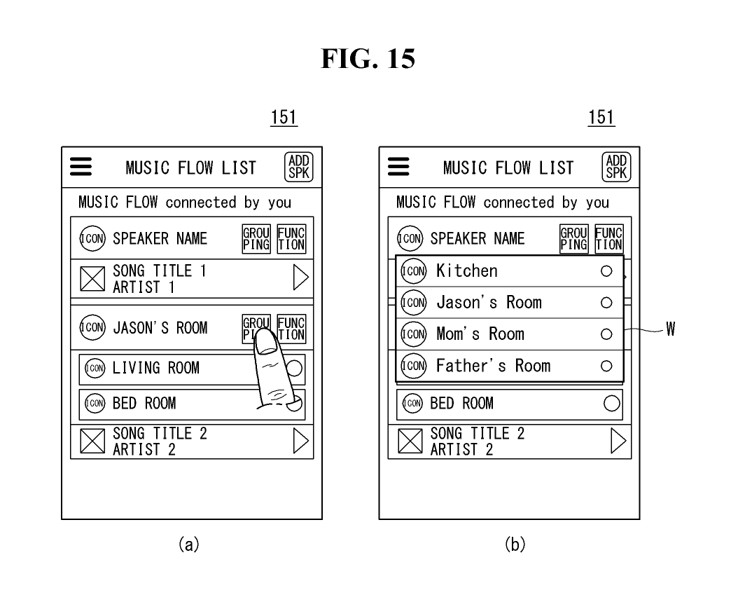

FIGS. 15 to 17 are diagrams illustrating a method of setting and managing a group of a plurality of speakers included in a local network in an electronic device according to an exemplary embodiment of the present invention.

Referring to FIG. 15, when a menu icon and a plurality of speaker information included in a local network are displayed, the controller (180 of FIG. 4) may generate a group through a touch input to the menu icon. That is, the controller may generate a group through a drag input of a plurality of speaker information and may generate a group by touching a menu icon.

Specifically, when a touch input to a ‘Grouping’ icon of a JASON'S ROOM is received, the controller may control to display a list that can select speakers to be included in the same group as that of the JASON'S ROOM into a popup window w.

The controller may select at least one speaker of a speaker list displayed in the popup window w and include the selected speaker in the JASON'S ROOM. For example, when a Mom's Room speaker is selected, in a JASON'S ROOM group, a JASON'S ROOM speaker, a LIVING ROOM speaker, a BED ROOM speaker, and a Mom's Room speaker may be included.

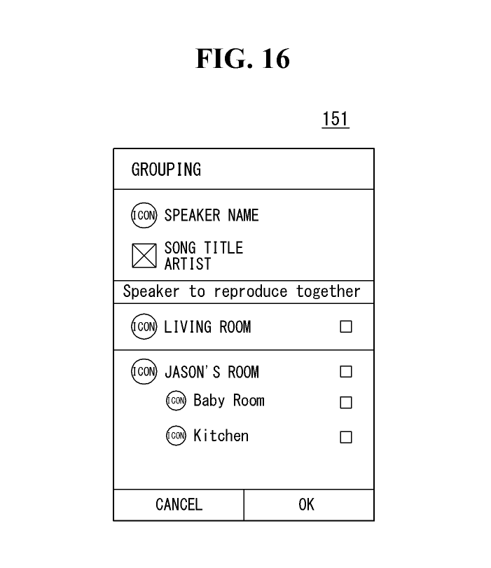

Referring to FIG. 16, the controller (180 of FIG. 4) may control to display a screen that selects whether operation of at least one speaker included in a group is subordinated to operation of a main speaker on the touch screen 151.

Specifically, the controller may select a subordinated speaker to be reproduced together with a JASON'S ROOM speaker among speakers included in a JASON'S ROOM group. Although not shown in FIG. 16, the controller may control to subordinate only a specific function (e.g., volume size, reproduction list) other than a reproduction operation to the main speaker.

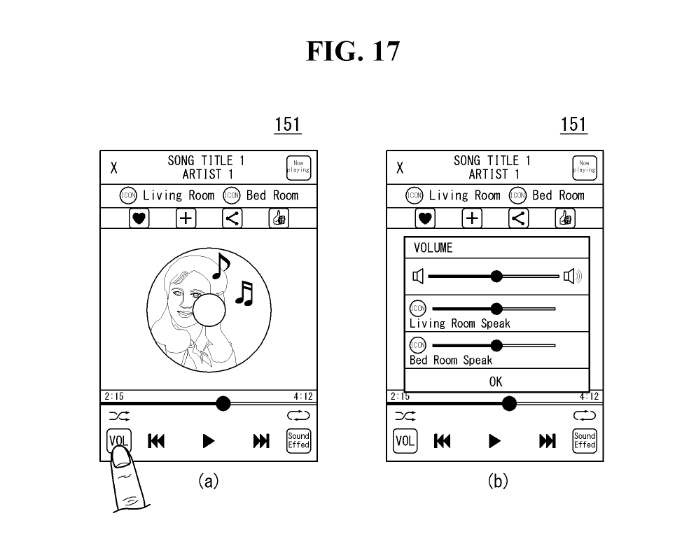

Referring to FIG. 17, the controller (180 of FIG. 4) may individually control a volume of a plurality of speakers included in a group.

Specifically, while reproducing music with a specific speaker, when a volume icon VOL is selected, the controller may control to display a volume of an entire speaker included in the same group as that of the specific speaker on a touch screen. When a volume of the specific speaker is adjusted, in order to simultaneously adjust a volume of an entire speaker included in the same group, the controller may transmit a control signal to speakers included in the group. Further, when adjusting a volume of another second speaker other than the specific speaker, in order to change only a volume of the second speaker, the controller may transmit a control signal to the second speaker.

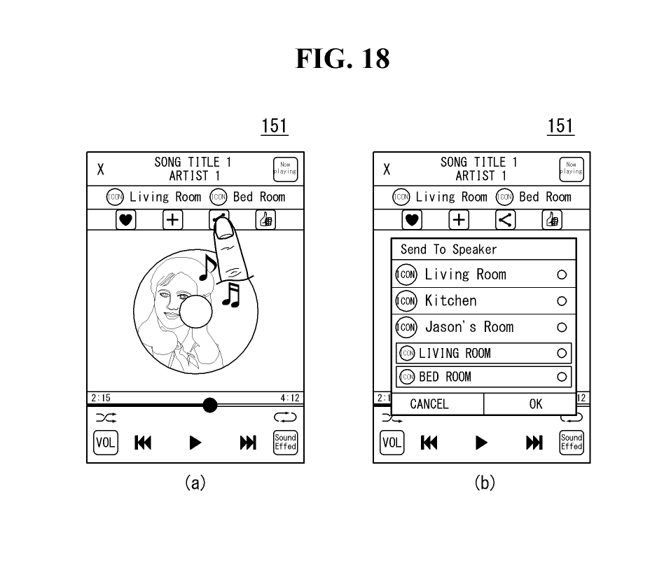

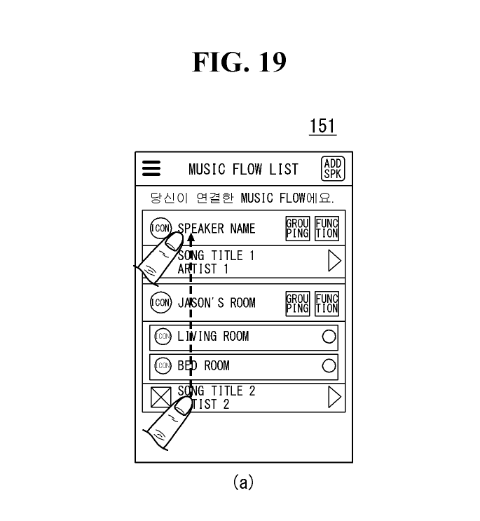

FIGS. 18 and 19 are diagrams illustrating a method of sharing a music reproduction list between a plurality of speakers included in a local network in an electronic device according to an exemplary embodiment of the present invention.

Referring to FIG. 18, the controller (180 of FIG. 4) may control to display reproduction music information and a menu icon of a specific speaker on a touch screen and to share reproduction music of a specific speaker with another speaker through a touch input to a sharing icon among menu icons.

When a touch input to a sharing icon is received, the controller may control to display a speaker list to share on a touch screen. The speaker list to share is a speaker list connected to a local network.

When a speaker to share reproduction music is selected, in order to transmit a reproduction music file from a specific speaker to a selected speaker, the controller may transmit a control signal to each speaker. In this case, the controller may directly transmit a control signal to each speaker or may transmit a control signal through the wireless access device.

Referring to FIG. 19, when receiving an input that drags reproduction music information of a specific speaker to an area in which information about another speaker is displayed, the controller (180 of FIG. 4) may control to share reproduction music of the specific speaker with another speaker.

A detailed method of sharing music is the same as a method described with reference to FIG. 18.

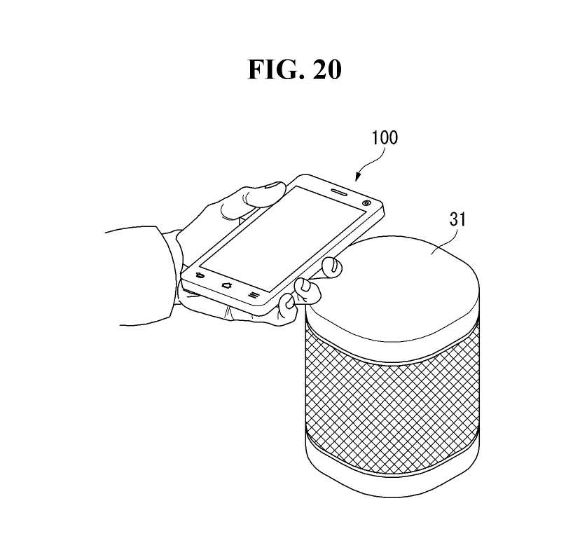

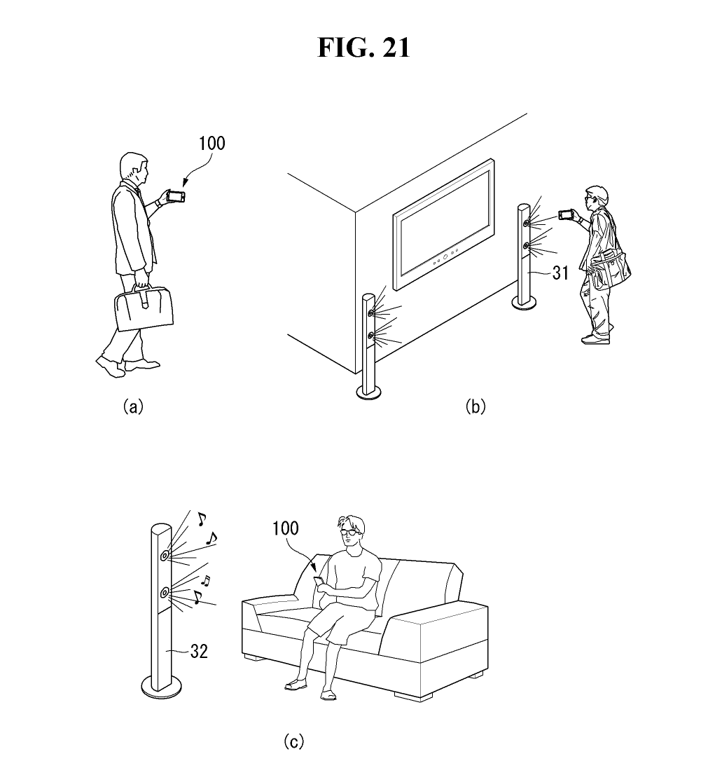

FIGS. 20 and 21 are diagrams illustrating a method of continuously reproducing music in a plurality of speakers included in a local network in an electronic device according to an exemplary embodiment of the present invention.

Referring to FIG. 20, the controller (180 of FIG. 4) may detect a tagging signal of a plurality of speakers through the sensing unit (140 of FIG. 4) or a detection signal using BLE technology.

When the electronic device approaches into a preset distance from a specific speaker, the controller performs tagging using NFC technology, thereby receiving location information of the speaker or receiving indoor location information of the speaker using BLE technology.

Referring to FIG. 21, the controller (180 of FIG. 4) may control to continuously reproduce reproducing music with the mobile terminal 100 outdoors through another speaker installed indoors.

Specifically, when a tagging signal or a detection signal is received from a first speaker by entering to indoor, the controller may stop a music output of the mobile terminal and control the first speaker to transmit and continuously reproduce a reproducing music file to the first speaker.

Further, when a tagging signal or a detection signal is received from a second speaker by entering to a living room, the controller may stop a music output of the first speaker and control the second speaker to transmit and continuously reproduce a reproducing music file to the second speaker.

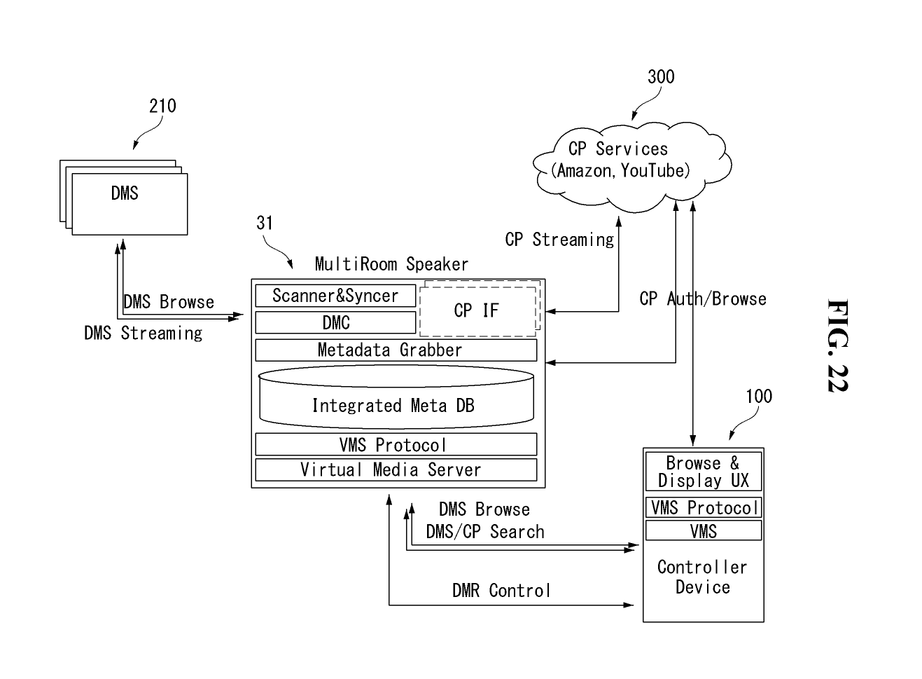

FIGS. 22 to 27 are diagrams illustrating a method of integrally managing a music file in a main speaker included in a local network in an electronic device according to an exemplary embodiment of the present invention.

Referring to FIG. 22, the controller (180 of FIG. 4) may control a specific speaker 31 included in a local network to integrally manage a music file of the DMS 210, the CP server 300, and the electronic device 100.

Specifically, the controller (180 of FIG. 4) of the electronic device 100 may transmit information of the DMS 210 and the CP server 300 to the specific speaker 31 and connect from the specific speaker 31 to the DMS 210 and the CP server 300 to control to receive a music file. Further, the controller (180 of FIG. 4) may transmit a music file stored within the electronic device 100 to the specific speaker 31 to control the specific speaker 31 to integrally manage a music file in which the electronic device included in a local network can access.

The specific speaker 31 according to an exemplary embodiment of the present invention may include a Scanner & Syncer, a DMC, a CP I/F, a Metadata Grabber, an Integrated Meta DB, a VMS Protocol, and a Virtual Media Server.

The Scanner & Syncer may perform a function of searching for a DMS inner container and an item, the DMC may perform a function of detecting a DMS on a local network, and the DMS may perform a function of a query request and response. The CP I/F may implement login, authentication, and streaming of the CP server, the Metadata Grabber may extract Metadata and define a Metadata extraction item, and the Integrated Meta DB may store DMS Metadata and transmit a music file to a subordinated speaker. The VMS Protocol may provide an interlocking protocol between the electronic device and the VMS and provide a control API, and the Virtual Media Server may perform a function of providing a virtual media server and managing a music file.

The electronic device 100 according to an exemplary embodiment of the present invention may include a Browse & Display UX, a VMS Protocol, and a Virtual Media Controller.

The Browse & Display UX provides a user UX, the VMS Protocol manages a protocol that interlocks with the VMS, and the Virtual Media Controller performs a function of inquiring and reproducing contents by interlocking with the VMS.

By a function of a configuration of the specific speaker 31 and the electronic device 100, the specific speaker 31 may integrally manage a music file that can access in a local network.

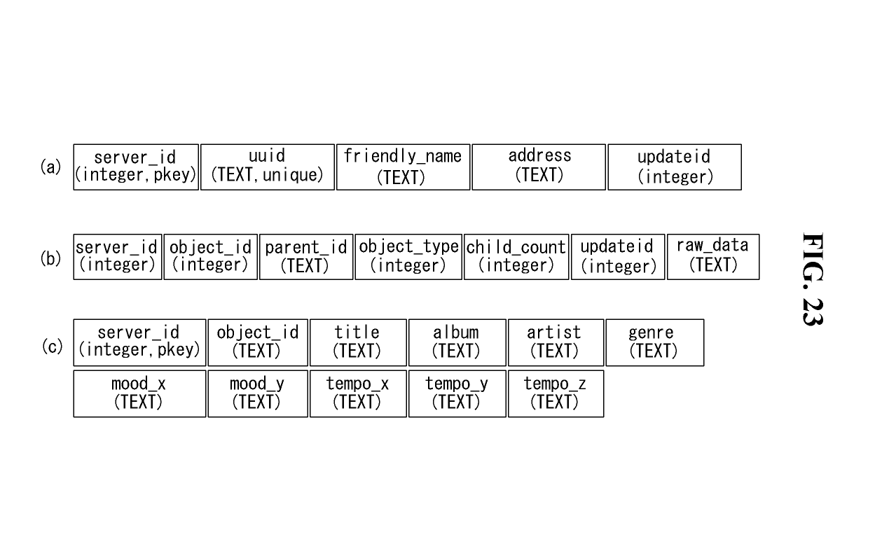

Referring to FIG. 23, an integrated database format in which a specific speaker manages may include DMS information, object search information, DLNA Metadata, and Metadata of each content and information about a search key.

Specifically, (a) of FIG. 23 illustrates table_dms that stores DMS information, FIG. 23B illustrates search information of contents within the DMS and a table_object that stores DLNA Metadata, and (d) of FIG. 23 illustrates table_metadata that stores Metadata of contents and that stores a search key.

Therefore, a music file that can access through a local network may be integrally managed using an integrated database format, and information about the found music file may be updated and stored.

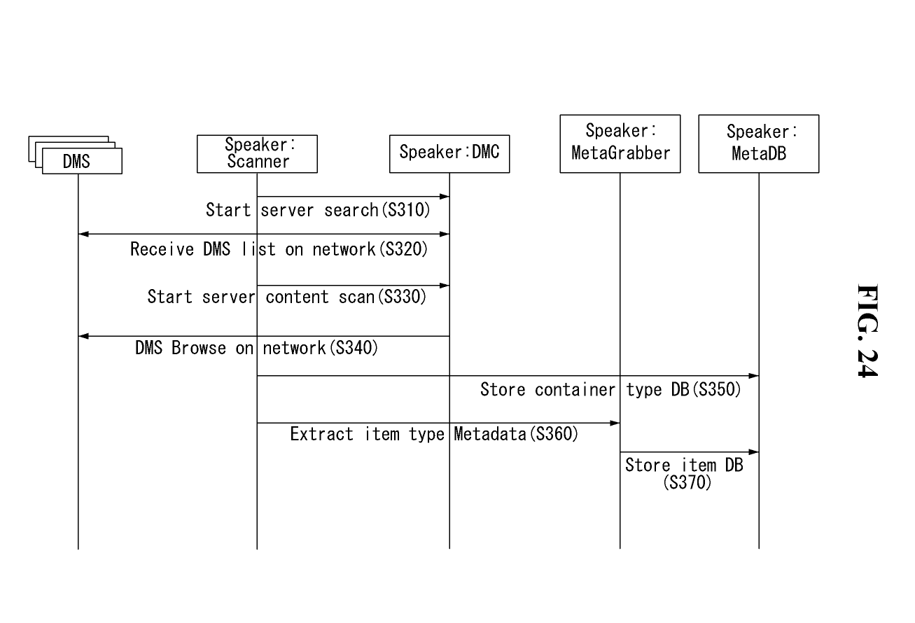

Referring to FIG. 24, a Scanner of a specific speaker of the local network may request a server search to a DMC of the specific speaker (S310), and the DMC of the specific speaker may receive a DMS list on a local network from the DMS (S320). The Scanner of the specific speaker starts content scan with the DMC of the specific speaker (S330).

Thereafter, the DMC of the specific speaker requests a DMS search on the network to the DMS (S340), the Scanner of the specific speaker stores a container type database, extracts Metadata of an item type (S350, S360), and stores an item database (S370). Steps S340 to S370 are repeated to a final node of a DMS content tree, and by performing steps S330 to S370 for entire DMS on the local network, Metadata of contents in which a specific speaker is to integrally manage may be generated.

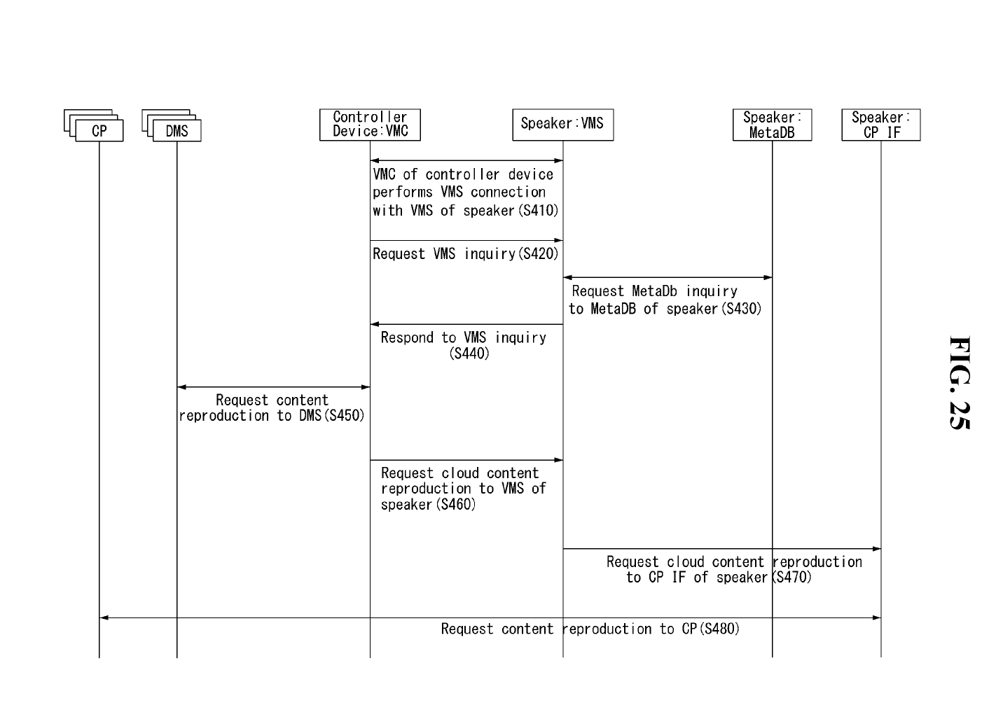

Referring to FIG. 25, a VMC of a controller device may perform a VMS connection with a VMS of a specific speaker (S410).

Thereafter, the VMC of the controller device requests a VMS inquiry of the specific speaker to the VMS of the specific speaker (S420) and requests a Metadatabase inquiry to a Metadatabase of the specific speaker (S430), and the VMS of the speaker may respond to the VMS inquiry to the VMC of the controller device (S440). Steps S420 to S440 may be repeated until the user selects reproduction.

The VMC of the controller device may request content reproduction to the DMS (S450) and may request cloud content reproduction to the VMS of the specific speaker (S460). The VMS of the specific speaker may request cloud content reproduction to a CP IF of the specific speaker (S470), and the CP IF of the specific speaker may request content reproduction to the CP (S480).

That is, contents (e.g., music file) integrally managed in the specific speaker may be reproduced according to the path.

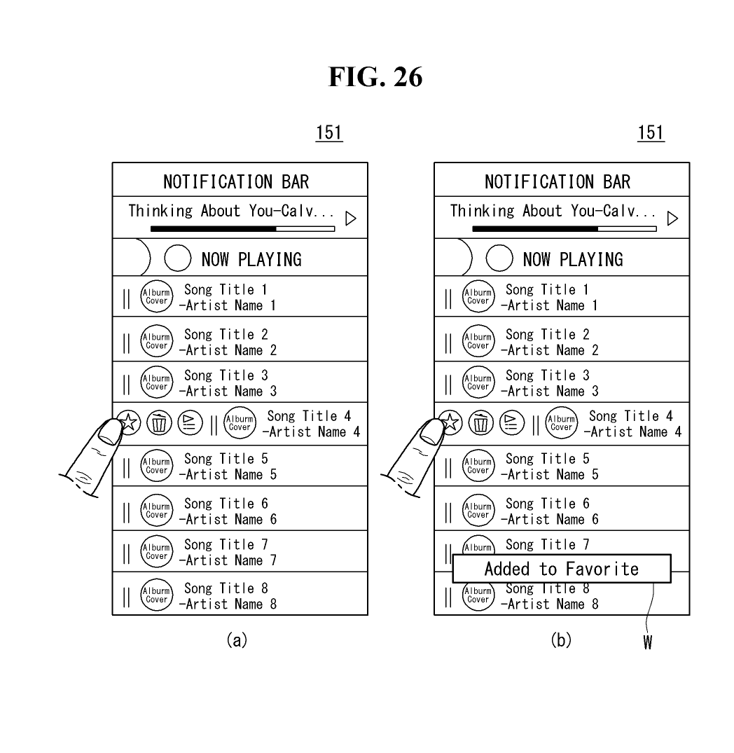

Referring to FIG. 26, when editing specific music included in a music reproduction list, the controller (180 of FIG. 4) may store edition contents at an integrated database.

Specifically, when performing favorite registration of a Song Title 4 in a music reproduction list of a first speaker, the controller may control to store a content in which the Song Title 4 is registered at Favorites at the integrated database and to provide a favorite list in which the Song Title 4 is included, when a second speaker or a third speaker requests a favorite list.

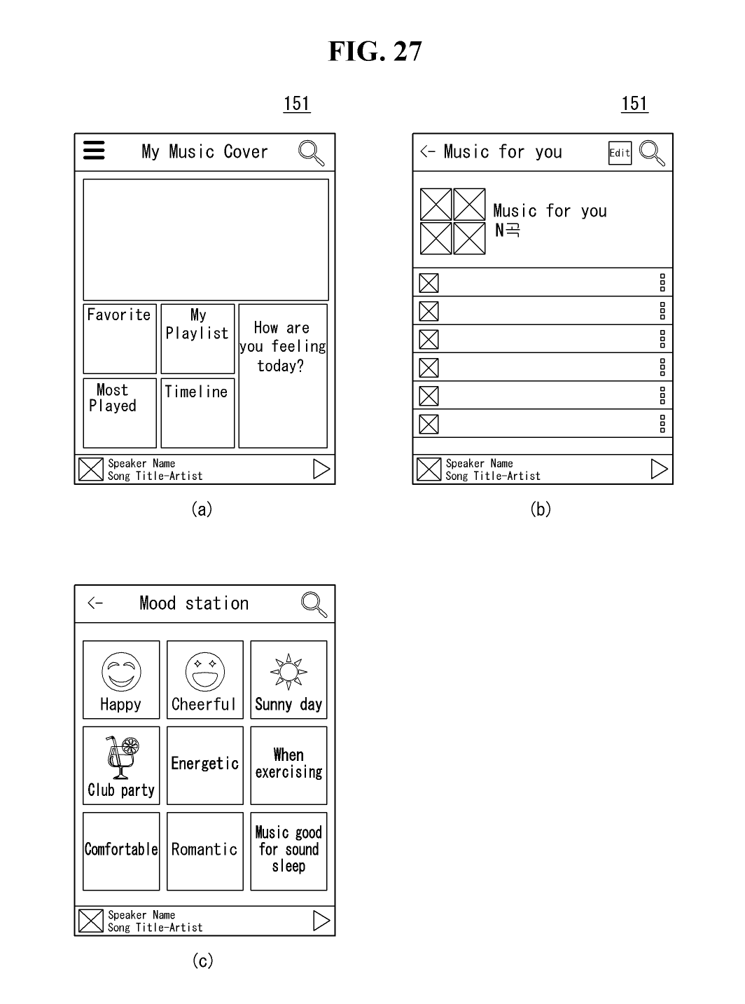

Referring to FIG. 27, the controller (180 of FIG. 4) may control to display a screen that recommends music according to a specific condition among music files managed in an integrated database on a touch screen.

For example, in other speakers included in a local network, when a plurality of music is registered in a My Playlist, registered entire music may be displayed in the My Playlist. Further, in a reproduction list reproduced in another speaker, a list in which the reproduction number is equal to or larger than the preset number may be displayed in Most Played.

The controller may integrally manage an event that has occurred in a plurality of speakers included in a local network using an integrated database in which a specific speaker integrally manages and may search for and provide a music file from an integrated database to which an event that has occurred in each speaker is reflected.

Further, the controller may recommend a music list appropriate to a user using an integrated database. In this case, a recommendation condition may consider a previous music reproduction history and a music genre registered in a favorite list.

As described above, a method of controlling an electronic device according to the present invention may be recorded and provided on a computer readable recording medium with a program for executing in a computer.

A method of controlling an electronic device according to the present invention may be executed through software. When being executed with software, constituent means of the present invention are code segments that execute a necessary work. A program or code segments may be stored at a processor readable medium or may be transmitted by a computer data signal that is coupled to a carrier in a transmitting medium or a communication network.

A computer readable recording medium includes an entire kind of record device that stores data that may be read by a computer system. A computer readable recording device may include, for example, a read-only memory (ROM), a random-access memory (RAM), a compact disc-ROM (CD-ROM), a digital versatile disk-ROM (DVD_ROM), a digital versatile disk-RAM (DVD_RAM), a magnetic tape, a floppy disk, a hard disk, and an optical data storage. Further, in the computer readable recording medium, codes that are distributed in a computer system connected to a network and in which a computer may read with a distributed method may be stored and executed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An electronic device, comprising:
a wireless communication unit; and
a controller configured to:
connect to a wireless access device through the wireless communication unit to receive local network information, and
receive the local network information to a first speaker, and
request sharing of the local network information to at least one second speaker that can synchronize with the first speaker through the first speaker.

2. The electronic device of claim 1, further comprising a touch screen,
wherein the controller is configured to connect to the wireless access device to receive information about a plurality of speakers included in a local network, to control to display information about the plurality of speakers on the touch screen, and to control to display information about each speaker in a partitioned area or into a representative icon comprising information about the each speaker.

3. The electronic device of claim 2, wherein the controller is configured to generate a speaker corresponding to a start point and an end point of a drag input into one group and to generate a control signal that controls to subordinate a speaker corresponding to the end point of the drag input to a speaker corresponding to the start point of the drag input, when receiving the drag input to the partitioned area or the representative icon.

4. The electronic device of claim 3, wherein the controller is configured to transmit the control signal to a subordinated speaker through the wireless access device.

5. The electronic device of claim 3, wherein the controller is configured to control to integrate a partitioned area that displays information about speakers included in the generated group and to display the integrated area on the touch screen or to control to integrate a representative icon comprising information about speakers included in the generated group into one group icon and to display the integrated icon on the touch screen.

6. The electronic device of claim 5, wherein the controller is configured to control to further display a screen that selects whether to subordinate at least one speaker formed into the group to operation of a main speaker on the touch screen.

7. The electronic device of claim 2, wherein the controller is configured to generate speakers corresponding to a drag input into one group and to control to distribute and output a multichannel output signal to speakers included in the generated group according to a drag direction, when receiving the drag input to the partitioned area or the representative icon.

8. The electronic device of claim 2, further comprising a sensing unit configured to detect a tagging signal of the plurality of speakers or a detection signal using Bluetooth Low Energy (BLE) technology,
wherein the controller is configured to store location information of the electronic device as location information of each speaker and to control the touch screen to display the partitioned area or the representative icon to correspond to the location information, when the sensing unit detects a tagging signal or a detection signal.

9. The electronic device of claim 8, wherein the controller is configured to transmit the tagging signal or the detection signal to other speakers included in the same group and to control speakers included in the group to continuously reproduce music, when the sensing unit detects a tagging signal or a detection signal.

10. The electronic device of claim 2, wherein the controller is configured to control to display a menu icon that sets music reproduction information and a surround effect of the first speaker or a specific speaker of the at least one second speaker on the touch screen and to control to display a screen that sets a speaker to give a surround effect to the specific speaker, when receiving an input to a menu icon that sets the surround effect.

11. The electronic device of claim 2, wherein the controller is configured to control to display a menu icon that sets sharing of music reproduction information and a reproduction music list of the first speaker or a specific speaker of the at least one second speaker on the touch screen and to control to display a speaker list that can share the reproduction music list, when receiving an input to a menu icon that sets sharing of the reproduction music list.

12. The electronic device of claim 1, wherein the controller is configured to transmit a music file of other electronic devices included in the local network to the first speaker and to control the first speaker and the another electronic device to enable the first speaker to integrally manage the music file.

13. The electronic device of claim 12, wherein the controller is configured to transmit the control signal to the first speaker so as to integrally manage the music file, when a control signal for integration management of the music file is input to a specific speaker included in the local network.

14. A method of controlling an electronic device, the method comprising:
connecting to a wireless access device to receive local network information;
transmitting the local network information to a first speaker and requesting sharing of the local network information to at least one second speaker that can synchronize with the first speaker through the first speaker;
receiving, when the first speaker and the at least one second speaker connect to the wireless access device, information about the connected plurality of speakers; and
displaying the information about the plurality of speakers into a partitioned area or a representative icon.

15. The method of claim 14, further comprising:
receiving a drag input to the partitioned area or the representative icon;
generating speakers corresponding to the drag input into a group; and
integrally displaying an area or a representative icon in which information about speakers included in the generated group is displayed into one area or a group icon.
